(19) United States
(12) Patent Application Publication
(10) Pub. No.: US 2010/0202772 A1
(43) Pub. Date: Aug. 12, 2010

(54) Method and Device For Validating a Link Attribute In The Nodes Of Automatically Switched Optical Network

(75) Inventors: Xueqin Wei, Hubei Province (CN); Ran Song, Hubei Province (CN)

Correspondence Address: BRINKS HOFER GILSON & LIONE, P.O. BOX 10395, CHICAGO, IL, 60610, US

(73) Assignee: Fiberhome Telecommunication Technologies Co., Ltd.

(21) Appl. No.: 12/678,549

(22) PCT Filed: Jul. 25, 2008
(86) PCT No.: PCT/CN08/71759

§ 371 Date: Mar. 17, 2010

(30) Foreign Application Priority Data
Sep. 19, 2007 (CN) 200710154799.X

(51) Int. Cl. H04B 17/00

(52) U.S. Cl. 398/16

(57) ABSTRACT

The invention provides a method and device for verify link attributes in a node of an Automatically Switched Optical Network. In the Automatically Switched Optical Network, the node and another node are connected to a first port and a second port of one bidirectional link respectively, and the bidirectional link is divided into a first unidirectional link from the first port to the second port and a second unidirectional link from the second port to the first port. The method comprising the steps of: configuring a plurality of link attributes of the first unidirectional link in the node; receiving in the node a plurality of link attributes of the second unidirectional link configured in the another node from the another node; and comparing in the node the plurality of link attributes of the first unidirectional link with the received plurality of link attributes of the second unidirectional link respectively to check whether they match each other.

### FIELD OF THE INVENTION

The invention relates to an Automatically Switched Optical Network, and more specifically, the invention relates to a method and device verifying link attributes in nodes of an Automatically Switched Optical Network.

### DESCRIPTION OF RELATED ART

As a next generation optical transport network, the Automatically Switched Optical Network (ASON) includes three functional planes, i.e. a management plane, a control plane, and a transport plane. Through collaboration of the three planes, permanent connections (PC), soft permanent connections (SPC), and switched connections (SC) may be provided between nodes. At the same time, through the collaboration of the three planes, intelligent functions, such as automatic discovery and so on, are further provided.

In the ASON, it is necessary to flood network topology and link information to the entire network through a routing protocol, so that each node in the network knows the topology of the entire network and link attributes of each link in the network. The link attributes include bandwidth information of the link, a protection attribute of the link, a signal type of the link, and so on.

In the ASON, a bidirectional link is treated as two unidirectional links, so as to be compatible with current protocol systems and meanwhile enable the ASON to support unidirectional services. This bidirectional link has two ports, and two nodes (i.e., neighboring nodes) are connected to the two ports respectively. For one of the two nodes, the two ports are respectively a local port and a remote port. FIG. 1 schematically shows two nodes and a bidirectional link therebetween in an ASON, in which the bidirectional link is shown as two unidirectional links, and arrows in this figure express directions of the two unidirectional links. As shown in FIG. 1, node 1 and node 2 are connected to each other through the bidirectional link. For node 1, port X is the local port (located in node 1), port Y is the remote port (located in node 2), the unidirectional link from node 1 to node 2 (or from port X to port Y) is a transmission link, and the unidirectional link from node 2 to node 1 is a receiving link; conversely, for node 2, port Y is the local port, port X is the remote port, the unidirectional link from node 2 to node 1 (or from port Y to port X) is a transmission link, and the unidirectional link from node 1 to node 2 is a receiving link.

After establishment of the ASON network, local link port attributes and remote link port attributes of the respective transmission links of node 1 and node 2 are stored in control planes of node 1 and node 2, in which the local link port attributes are configured to the control planes of the nodes by a network management system or reported to the control planes of the nodes automatically by transport planes, and the remote link port attributes are obtained by an LMP (Link Management Protocol) of the remote node through protocol interaction between the two nodes. Therefore, by way of an example, the following link information is stored respectively in local link databases of node 1 and node 2 after configuration of the link attributes has been completed:

The local link database of node 1
(the unidirectional link from node 1 to node 2)

| | |
|---|---|
| Local port | X |
| Remote port | Y |
| Signal Type | SDH |
| Total bandwidth | 64 |
| (number of VC-4) | |
| Available bandwidth | 32 |
| (number of VC-4) | |
| Supportable maximum contiguous | STM-16 |
| concatenation type | |
| Link protection attribute | No protection |

The local link database of node 2
(the unidirectional link from node 2 to node 1)

| | |
|---|---|
| Local port | Y |
| Remote port | X |
| Signal Type | SDH |
| Total bandwidth | 64 |
| (number of VC-4) | |
| Available bandwidth | 32 |
| (number of VC-4) | |
| Supportable maximum contiguous | STM-16 |
| concatenation type | |
| Link protection attribute | No protection |

Then, a link management protocol module in each of the nodes provides the link information stored locally to a routing protocol module of this node, which floods the link information to the entire network via the routing protocol.

However, because of packet loss when the network management system configures the link attributes, an error occurring in the interaction process of the control planes, or other reasons, a mismatch may occur between corresponding link attributes of the two unidirectional links respectively configured in the two nodes, i.e., corresponding link attributes in two directions of the bidirectional link. In order to find the error that may occur during configuration of the link attributes, the LMP protocol specified by IETF (Internet Engineering Task Force) prescribes that, before the link attributes are flooded to the entire network, messages about signal types, local port identifiers, and remote port identifiers of two unidirectional links respectively configured by neighboring nodes in the network are exchanged between the neighboring nodes, and it is verified whether the three kinds of link attributes of the two unidirectional links respectively match each other. If it is found that the signal types, the local port identifiers, or the remote port identifiers of the two unidirectional links respectively configured by the two nodes do not match each other, an alarm is generated. Currently, no function of verifying link attributes is specified in related standards and recommendations of ITU (International Telecommunication Union) and OIF (Optical Internetworking Forum).

However, link attributes of a link includes the total bandwidth, the available bandwidth, the supportable maximum contiguous concatenation type, the protection attributes, and so on of this link, besides the signal type, the local port identifier, and the remote port identifier as described above; and, in practice, when configured link attributes in two directions of a bidirectional link do not match each other due to packet loss when the network management system configures the link attributes or an error in an interaction process of control planes, the mismatched link attributes are not always the three kinds of link attributes, i.e. the signal types, the local port identifiers, and the remote port identifiers. In this case, since the current LMP protocol of IETF only specifies verifying the above three kinds of link attributes without verifying other link attributes, when other link attributes in two directions of the bidirectional link do not match each other, the mismatched link attributes will be flood to the entire network as they are via the routing protocol, causing problems occurring on the entire network, for example, causing failure of establishment of a new connection or a crackback due to failure of dynamic re-routing.

### SUMMARY OF THE INVENTION

In order to solve the above problem, the invention extends the LMP protocol specified by IETF. An object of the invention is to provide an enhanced link attribute verification method and device for verifying link attributes in a node of an Automatically Switched Optical Network (ASON). The link attribute verification method and device according to the invention not only verify whether local port identifiers, remote port identifiers and signal types of links match each other respectively, but also verify whether total bandwidths, available bandwidths, supportable maximum contiguous concatenation type, and protection attributes of the links match each other respectively, thereby avoiding errors from occurring in the network because the mismatched link attributes are flooded to the entire network.

According to an aspect of the invention, there is provided a method for verifying link attributes in a node of an Automatically Switched Optical Network, the node and another node being connected to a first port and a second port of one bidirectional link respectively, the bidirectional link being divided into a first unidirectional link from the first port to the second port and a second unidirectional link from the second port to the first port, the method comprising the steps of configuring a plurality of link attributes of the first unidirectional link in the node; receiving in the node a plurality of link attributes of the second unidirectional link configured in the another node from the another node; and comparing in the node the plurality of link attributes of the first unidirectional link with the received plurality of link attributes of the second unidirectional link respectively to check whether they match each other.

According to another aspect of the invention, there is provided a device for verifying link attributes in a node of an Automatically Switched Optical Network, the node and another node being connected to a first port and a second port of one bidirectional link respectively, the bidirectional link being divided into a first unidirectional link from the first port to the second port and a second unidirectional link from the second port to the first port, the device comprising a local link database for storing a plurality of link attributes of the first unidirectional link configured in the node; a link management protocol module for receiving a plurality of link attributes of the second unidirectional link configured in the another node from the another node, and comparing the plurality of link attributes of the first unidirectional link stored in the local link database with the received plurality of link attributes of the second unidirectional link respectively to check whether they match each other.

By the link attribute verification method and device according to the invention, verification of a plurality of link attributes in two directions of a bidirectional link may be performed at the time of initialization of a node or periodically, thus it is possible to find mismatched link attributes automatically and adopt proper subsequent operations, thereby guaranteeing usability and safety of the network more reliably and avoiding deterioration of the network.

### BRIEF DESCRIPTION OF THE DRAWINGS

FIG. 1 schematically shows two nodes and a bidirectional link therebetween in an ASON;

FIG. 2 schematically shows interfaces between protocols and an interface between protocols and a network management system in an ASON;

FIG. 3 is a block diagram of a device for verifying link attributes in a node of an ASON according to a first embodiment of the invention;

FIG. 4 is a flow chart of a method for verifying link attributes in a node of an ASON according to the first embodiment of the invention;

FIG. 5 shows a message flow of the method for verifying link attributes in a node of an ASON according to the first embodiment of the invention;

FIG. 6 shows an example in which it is found that protection attributes of links do not match each other in a link verification process according to the first embodiment of the invention;

FIG. 7 shows an example in which it is found that available bandwidths of links do not match each other in a link verification process according to the first embodiment of the invention;

FIG. 8 shows an example in which it is found that supportable maximum contiguous concatenation types of links do not match each other in a link verification process according to the first embodiment of the invention;

FIG. 9 shows an example of eliminating an alarm indicating a mismatch of protection attributes of links according to the first embodiment of the invention;

FIG. 10 shows an example of eliminating a prompt indicating a mismatch of available bandwidths of links according to the first embodiment of the invention;

FIG. 11 shows an example of eliminating a prompt indicating a mismatch of supportable maximum contiguous concatenation types of links according to the first embodiment of the invention; and

FIG. 12 is a flow chart of a method for verifying link attributes in a node of an ASON according to a second embodiment of the invention.

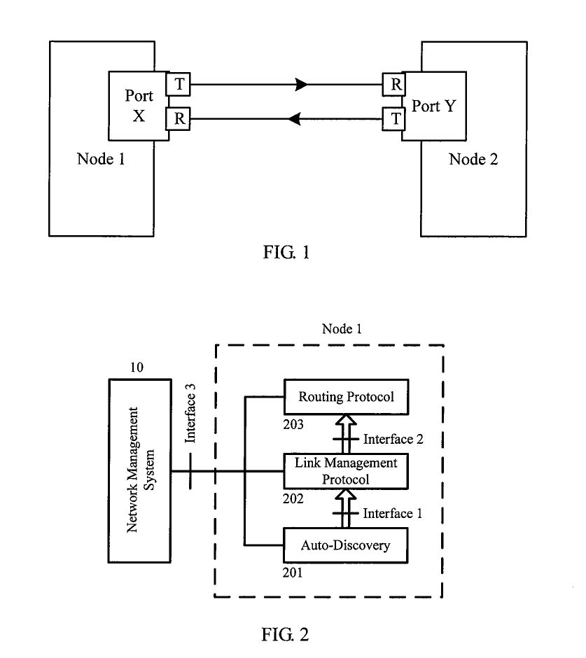

### DETAILED DESCRIPTION OF THE INVENTION

Hereinafter, embodiments of the invention are described in detail with reference to attached figures. It should be understood that these embodiments are only for the purpose of illustration, instead of limiting the scope of the invention.

As mentioned above, a bidirectional link in an ASON is treated as two unidirectional links so as to be compatible with unidirectional services, and link attributes are flooded to the entire network in accordance with the two unidirectional links. The link attributes of the two unidirectional links are respectively stored in local link databases of control planes of respective nodes, and comprise three parts, i.e. link attributes configured by default, link attributes configured by a network management system, and link attributes reported through auto-discovery.

FIG. 2 schematically shows interfaces between protocols and an interface between protocols and a network management system in an ASON. Referring to FIG. 2, node 1 includes an auto-discovery module 201, a link management protocol module 202, and a routing protocol module 203. The link management protocol module 202 is connected to a network management system 10 via an interface 3. The auto-discovery module 201 is used to automatically discover link attributes of the node, such as a local port identifier, a remote port identifier, a link signal type, and so on, and automatically report these link attributes to the link management protocol module 202 of the control plane via an interface 1. The network management system 10 may also configure the link attributes to the link management protocol module 202 of the control plane of node 1 via the interface 3. These link attributes are stored in a local link database (not shown) of the control plane when the configuration of the link attributes is completed. After the verification as described above is performed, the link management protocol module 202 sends these link attributes to the routing protocol module 203 via the interface 2, then the routing protocol module 203 floods these link attributes to the entire network.

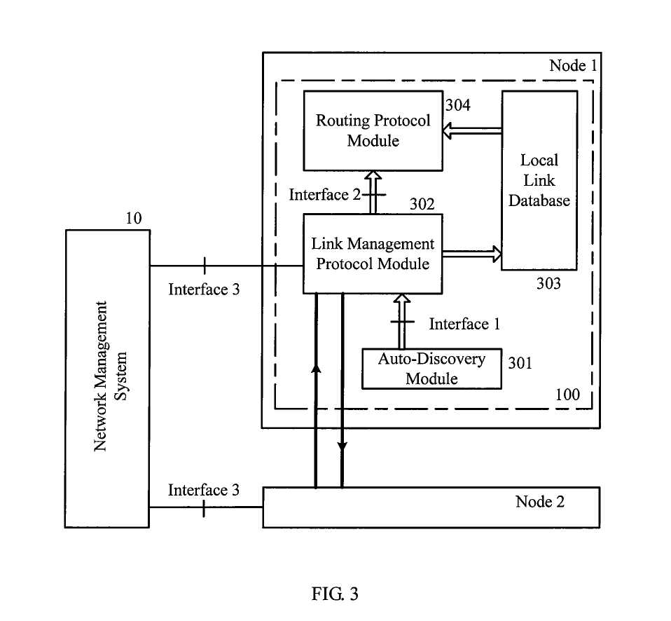

FIG. 3 is a block diagram of a device for verifying link attributes in a node of an ASON according to the first embodiment of the invention.

As shown in FIG. 3, two adjacent nodes, i.e. node 1 and node 2, are connected to the network management system 10, and are connected with each other through a bidirectional link which is shown as two unidirectional links. Since node 2 has a similar structure to that of node 1 and performs similar operations to those performed by node 1, only the structure and operations of a link attribute verification device 100 in node 1 are described in detailed below for the sake of simplicity.

The device 100 for verifying link attributes in node 1 includes an auto-discovery module 301, a link management protocol (LMP) module 302, a local link database 303, and a routing protocol module 304.

As described above, the auto-discovery module 301 in node 1 is used to automatically discover link attributes of a unidirectional link from node 1 to node 2, such as a local port identifier, a remote port identifier, a signal type, and so on, and automatically report these link attributes to the link management protocol module 302 of the control plane of node 1.

The link management protocol module 302 receives the link attributes reported from the auto-discovery module 301, and may also receive from the network management system 10 the link attributes of the unidirectional link from node 1 to node 2 which are configured by the network management system 10. Then, the link attributes are stored in the local link database 303 by the link management protocol module 302.

The local link database 303 belongs to the control plane of node 1, and stores the link attributes reported from the auto-discovery module 301 or the link attributes configured by the network management system 10. Additionally, the local link database 303 also stores link attributes of the unidirectional link which are obtained by a default configuration. As described above, the link attributes stored in the local link database 303 include a local port identifier, a remote port identifier, a signal type, a total bandwidth, an available bandwidth, a supportable maximum contiguous concatenation type, a protection attribute, and so on of the unidirectional link from node 1 to node 2. In addition, the local link database 303 also stores other network configuration information obtained when the link between node 1 and node 2 is established, including information about whether the unidirectional link from node 1 to node 2 carries a unidirectional service (or circuit), a bandwidth and a supportable maximum contiguous concatenation type of the carried unidirectional circuit (if any), and so on. It should be appreciated that a local link database in node 2 also stores corresponding information, including link attributes of the unidirectional link from node 2 to node 1, information about whether the unidirectional link from node 2 to node 1 carries a unidirectional service (or circuit), a bandwidth and a supportable maximum contiguous concatenation type of the carried unidirectional circuit (if any), and so on.

The routing protocol module 304 is used to flood the link attributes sent by the link management protocol module 302 to the entire network via a routing protocol, after a link attribute verification process described later.

Hereinafter, operations of the device 100 according to the invention are described in detail.

After the configuration of the link attributes is completed, the link management protocol module 302 sends a link/link attribute message to a link management protocol module in node 2, so as to send the local link attributes stored in the local link database 303 of node 1 to the link management protocol module in node 2. Similarly, when node 2 completes configuration of link attributes, its link management protocol module also sends the configured link attributes to the link management protocol module 302 in node 1 by using a link/link attribute message. Therefore, the link management protocol module 302 also receives the link/link attribute message about the unidirectional link from node 2 to node 1, which is sent by the link management protocol module of node 2. In the embodiments according to the invention, besides the local port identifier, the remote port identifier, and the signal type of the link (i.e. the unidirectional link from node 1 to node 2 or the unidirectional link from node 2 to node 1) which have been specified by the LMP of IETF currently, the link attributes sent by the message include the total bandwidth, the available bandwidth, the supportable maximum contiguous concatenation type, the protection attribute, and so on of the link.

Next, the link management protocol module 302 compares the link attributes of the transmission link (i.e. the unidirectional link from node 1 to node 2) stored in the local link database 303 with the link attributes of the receiving link (i.e. the unidirectional link from node 2 to node 1) received from node 2 one by one, so as to determine whether these attributes match each other. Specifically, the link management protocol module 302 compares the link attributes including the local port identifier, the remote port identifier, the signal type, the total bandwidth, the available bandwidth, the supportable maximum contiguous concatenation type, the protection attribute, and so on of the transmission link stored in the local link database 303 with the corresponding link attributes received from node 2 one by one, so as to see whether they match each other. It should be recognized that, as an alternative to comparing all of the above link attributes, only one or more of the above link attributes may be compared.

When the link management protocol module 302 finds that the link attributes of the two unidirectional links match each other completely, the link attribute verification passes. At this time, the link management protocol module 302 sends the link attributes of the unidirectional link from node 1 to node 2 to the routing protocol module 304. Then the routing protocol module 304 floods the received link attributes to the entire network via the routing protocol.

On the contrary, when the link management protocol module 302 finds that one or more of the link attributes of the two unidirectional links do not match each other, it issues an alarm or prompt that indicates the attributes do not match each other to the network management system 10 according to the types of the mismatched link attributes.

Specifically, when the link management protocol module 302 finds one or more of the local port identifiers, the remote port identifiers, the signal types, and the protection attributes of the two unidirectional links do not match each other, which means that an error occurs when the link attributes are configured because the two unidirectional links actually belong to the same one bidirectional link, the link management protocol module 302 sends at this time an alarm to the network management system 10 via the interface 3, and shields the two unidirectional links, so as to prevent other nodes from using these links by mistake and thus leading to a network failure. The alarm indicates all the mismatched link attributes in the plurality of link attributes.

On the other hand, when the link management protocol module 302 finds only one or more of the total bandwidths, the available bandwidths and the supportable maximum contiguous concatenation types of the two unidirectional links do not match each other, the mismatch may be normal because the two unidirectional links may carry unidirectional services (also called circuits) having different service attributes, respectively. At this time, the link management protocol module 302 sends a prompt indicating the mismatch of said attributes to the network management system 10 via the interface 3 so that maintenance personnel can take proper measures, and then sends the link attributes of the two links to the routing protocol module 304. The routing protocol module 304 floods the link attributes to the entire network.

As described above, node 2 performs similar operations to those performed by node 1. When the link management protocol module 302 in node 1 sends the configured link attributes of the unidirectional link from node 1 to node 2 to the link management protocol module in node 2, the link management protocol module in node 2 receives the link attributes, and performs operations similar to the operations described above, thereby obtaining a verification result similar to node 1. Thus, when node 1 sends the alarm or prompt to the network management system 10, node 2 will necessarily send a corresponding alarm or prompt to the network management system 10.

When receiving the alarms from node 1 and/or node 2, the network management system 10 notifies the maintenance personnel of the alarm via voice, display, or the like. Then, the maintenance personnel adjusts, according to service attributes of the services carried by the two unidirectional links which are stored in the local link databases in node 1 and/or node 2, the link attributes which are indicated by the alarms and configured respectively in node 1 and/or node 2 to make them match each other, and triggers again verification processes performed by node 1 and node 2 on the link attributes of the two links. At this time, since the previously mismatched link attributes have been adjusted to match each other, the link management protocol modules of node 1 and node 2 will find that the link attributes of the two links become matching each other completely through the verification processes, thus they send prompts that indicates this match respectively to the network management system 10 to eliminate the previous alarms, and remove the shielding on the two unidirectional links between node 1 and node 2. Then, the link management protocol modules of node 1 and node 2 respectively send the link attributes of the two links to the routing protocol modules of corresponding nodes, and the routing protocol modules flood the link attributes to the entire network. It should be noted that in the above link attribute verification processes triggered again, it is possible to verify all of the link attributes of the two unidirectional links between node 1 and node 2, or only those mismatched link attributes indicated by the alarms.

On the other side, when receiving the prompt from node 1 and/or node 2, the network management system 10 notifies the maintenance personnel of the prompt via voice, display, or the like. The maintenance personnel judges whether the two unidirectional links between node 1 and node 2 carry unidirectional circuits, and whether the bandwidths or the maximum contiguous concatenation types of the carried unidirectional circuits (if any) cause the mismatch of the link attributes indicated by the prompt, based on information on whether the two unidirectional links carry unidirectional circuits, and the bandwidths, the supportable maximum contiguous concatenation types, and so on of the carried unidirectional circuits (if any), which are stored in the local link databases of node 1 and/or node 2. If the two unidirectional links carry unidirectional circuits, and the bandwidths or the maximum contiguous concatenation types of the unidirectional circuits cause the mismatch of the total bandwidths, the available bandwidths, or the maximum contiguous concatenation types of the two unidirectional links, the mismatch is normal, therefore the maintenance personnel eliminates the prompt. Conversely, if the two unidirectional links do not carry unidirectional circuits, or although the two unidirectional links carry unidirectional circuits, the bandwidths or the maximum contiguous concatenation types of the carried unidirectional circuits do not cause the mismatch of the total bandwidths, the available bandwidths, or the maximum contiguous concatenation types of the two unidirectional links, then this means that an error occurred when the corresponding link attributes were configured. At this time, the maintenance personnel adjusts, according to the service attributes of the services carried by the two unidirectional links which are stored in the local link databases in node 1 and node 2, the link attributes which are indicated by the prompt and configured respectively in node 1 and/or node 2 to make them match each other, and triggers again verification processes performed by node 1 and node 2 on the link attributes of the two links. Similarly, since the previously mismatched link attributes have been adjusted to match each other, the link management protocol modules in node 1 and node 2 will find that the link attributes of the two links become matching each other completely through the verification processes, thus they send prompts that indicates this match respectively to the network management system 10 to eliminate the previous prompts. Then, the link management protocol modules of node 1 and node 2 send the adjusted link attributes indicated by the previous mismatching prompts to the routing protocol modules of the corresponding nodes, and these link attributes are flooded to the entire network by the routing protocol modules.

It is to be noted that the method of judging whether the two unidirectional links between node 1 and node 2 carry unidirectional circuits, and whether the bandwidths and the maximum contiguous concatenation types of the unidirectional circuits (if any) cause the mismatch of the corresponding link attributes, based on information on whether the two unidirectional links carry unidirectional circuits, and the bandwidths, the supportable maximum contiguous concatenation types, and so on of the unidirectional circuits (if any), which are stored in the local link databases when establishing the two unidirectional links is commonly known in the art, and thus the description thereof is omitted here for simplicity.

Furthermore, it should be appreciated that, although the adjusted link attributes of the two unidirectional links between node 1 and node 2 are flooded to the entire network in the above, it is also possible to flood all the link attributes of the two links to the entire network.

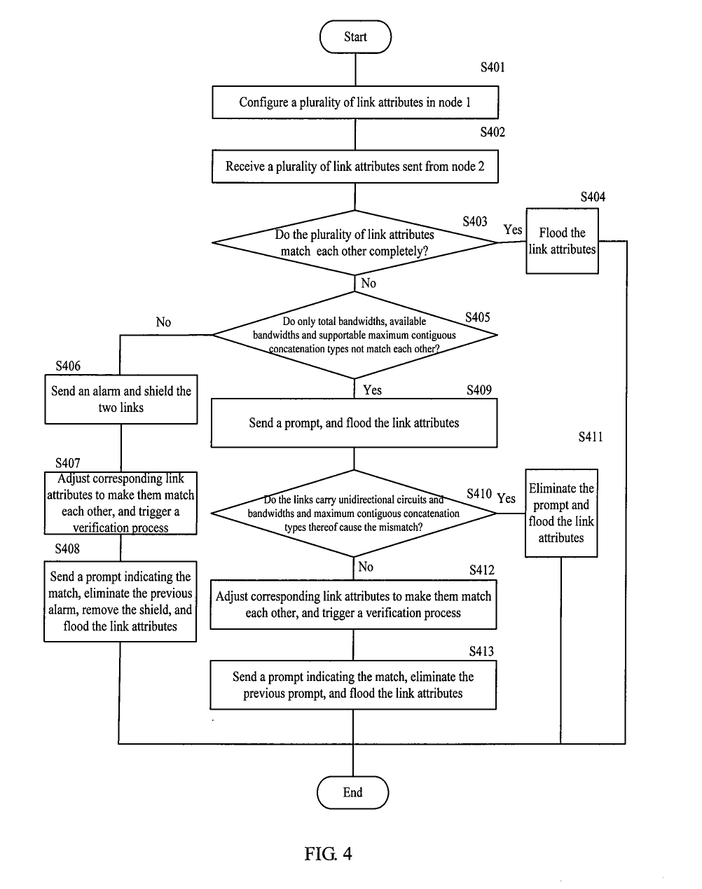

Hereinafter, the method for verifying link attributes in a node of an ASON according to the first embodiment of the invention is discribed with reference to FIG. 3 and FIG. 4. FIG. 4 is a flow chart showing the method for verifying link attributes performed in node 1 shown in FIG. 3. Likewise, node 2 performs the same operations, and the description thereof is omitted for simplicity.

As shown in FIG. 4, in step S401, a plurality of link attributes of the unidirectional link from node 1 to node 2, including the local port identifier, the remote port identifier, the signal type, the total bandwidth, the available bandwidth, the supportable maximum contiguous concatenation type, the protection attribute, and so on of the unidirectional link, are configured in node 1. As described above, the plurality of link attributes may be configured in the way of configuring the link attributes by default, configuring the link attributes to node 1 by the network management system 10, or reporting the automatically discovered link attributes by the auto discover module 301. After the configuration is completed, the link management protocol module 302 stores the plurality of link attributes in the local link database 303 of node 1.

In step S402, since node 2 sends to node 1 the link attributes of the unidirectional link from node 2 to node 1 through a link/link attribute message after completing the configuration, the link management protocol module 302 receives the link/link attribute message sent from node 2. The link/link attribute message includes, besides the local port identifier, the remote port identifier, and the signal type of the link currently specified by the LMP of IETF, the total bandwidth, the available bandwidth, the supportable maximum contiguous concatenation type, the protection attribute, and so on of the link. It should be appreciated that, in order to perform subsequent verification operations in node 2, the link management protocol module 302 of node 1 will also send a link/link attribute message to node 2 so as to send the plurality of link attributes of the unidirectional link from node 1 to node 2 which are stored in the local link database 303 to the link management protocol module in node 2.

Next, in step S403, the link management protocol module 302 compares the link attributes stored in the local link database 303 with the corresponding link attributes received from node 2 one by one, so as to determine whether these attributes match each other. As described above, the compared attributes include the local port names, the remote port names, the signal types, the protection attributes, the total bandwidths, the available bandwidths, the supportable maximum contiguous concatenation types, and so on of the two unidirectional links. And, in some cases, it is possible to verify only one or more of these link attributes.

When the link management protocol module 302 determines that the link attributes of the two unidirectional links match each other completely by the comparison in step S403, the process proceeds to step S404, where the link management protocol module 302 sends the link attributes of the unidirectional link from node 1 to node 2 to the routing protocol module 304, and the routing protocol module 304 floods these link attributes in the entire network.

On the contrary, when it is found in step S403 that one or more of the link attributes of the two unidirectional links do not match each other, the process proceeds to step S405. In step S405, the link management protocol module 302 determines whether the mismatched link attributes are only one or more of the total bandwidths, the available bandwidths, and the supportable maximum contiguous concatenation types. If the answer is negative, this means one or more of the local port identifiers, the remote port identifiers, the signal types, and the protection attributes of the two links do not match each other. Therefore, the process proceeds to step S406, in which the link management protocol module 302 sends an alarm to the network management system 10 and shields the two unidirectional links between node 1 and node 2, so as to prevent other nodes from using these links by mistake and thus leading to a network failure. As described above, the alarm indicates all the mismatched link attributes in the plurality of link attributes.

When receiving the alarm, the network management system 10 notifies the maintenance personnel of the alarm via voice, display, or the like. Then, in step S407, the maintenance personnel adjusts, according to service attributes of the services carried by the two unidirectional links which are stored in the local link databases of node 1 and/or node 2, the mismatched link attributes to make them match each other, and triggers again a verification process performed by node 1 on the link attributes of the two unidirectional links. It is to be noted that node 2 will send a similar alarm when node 1 sends the alarm, because node 2 performs similar operations to node 1. Accordingly, when the maintainer personnel triggers the verification process performed by node 1 on the link attributes, a verification process performed by node 2 on the link attributes will also be triggered. Additionally, as described above, the triggered verification processes are not limited to verifying all of the link attributes of the two unidirectional links between node 1 and node 2, instead, they may verify only those link attributes which do not match each other previously.

Next, in step S408, since the link management protocol modules in node 1 and node 2 find the link attributes of the two unidirectional links between node 1 and node 2 match each other completely, they send prompts indicating this match respectively to the network management system 10 to eliminate the previous alarms, then remove the shielding on the two links, and send the link attributes of the two unidirectional links to the routing protocol modules of node 1 and node 2 respectively, so that the routing protocol modules flood these to link attributes the entire network.

On the other hand, when it is determined in step S405 that only one or more of the total bandwidths, the available bandwidths and the supportable maximum contiguous concatenation types of the two links do not match each other, the process proceeds to step S409, in which the link management protocol module 302 of node 1 sends a prompt indicating the mismatch of the corresponding attributes to the network management system 10 so that the maintenance personnel can take proper measures, and send the link attributes of the two links to the routing protocol module 304 so as to flood them to the entire network.

Next, in step S410, the maintenance personnel judges whether the two unidirectional links between node 1 and node 2 carry unidirectional circuits, and whether the bandwidths and the maximum contiguous concatenation types of the unidirectional circuits (if any) cause the mismatch of the corresponding link attributes, based on information on whether the two unidirectional links carry unidirectional circuits, and the bandwidths, the supportable maximum contiguous concatenation types, and so on of the unidirectional circuits (if any), which are stored in the local link databases of node 1 and/or node 2 when the links between node 1 and node 2 are established.

If it is determined in step S410 that the two unidirectional links carry unidirectional circuits and the bandwidth or the maximum contiguous concatenation types of the unidirectional circuits cause the mismatch of the total bandwidths, the available bandwidths, or the maximum contiguous concatenation types of the two unidirectional links, the maintenance personnel eliminate the prompt in step S411. On the contrary, if it is determined in step S410 that the two unidirectional links do not carry unidirectional circuits, or although the two unidirectional links carry unidirectional circuits, the bandwidths or the maximum contiguous concatenation types of these unidirectional circuits do not cause the mismatch of the total bandwidths, the available bandwidths, or the supportable maximum contiguous concatenation types of the two unidirectional links, the process proceeds to step S412, in which the maintenance personnel adjusts, according to the service attributes of the services carried by the two unidirectional links which are stored in the local link databases in node 1 and/or node 2, the mismatched link attributes indicated by the prompt to make them match each other, and triggers again verification processes performed by node 1 and node 2 on the link attributes of the two unidirectional links.

Next, in step S413, since the previously mismatched link attributes have become matching each other, the link management protocol modules of node 1 and node 2 send to the network management system 10 prompts indicating this match respectively to eliminate the previous prompts, and send the adjusted link attributes which did not match each other as indicated by the previous prompts to respective routing protocol modules, so that the routing protocol modules flood the link attributes to the entire network. Likewise, the link attributes flooded by the routing protocol modules at this time are not limited to the previously mismatched link attributes, but may be all of the link attributes of the unidirectional links between node 1 and node 2. Then, the process ends.

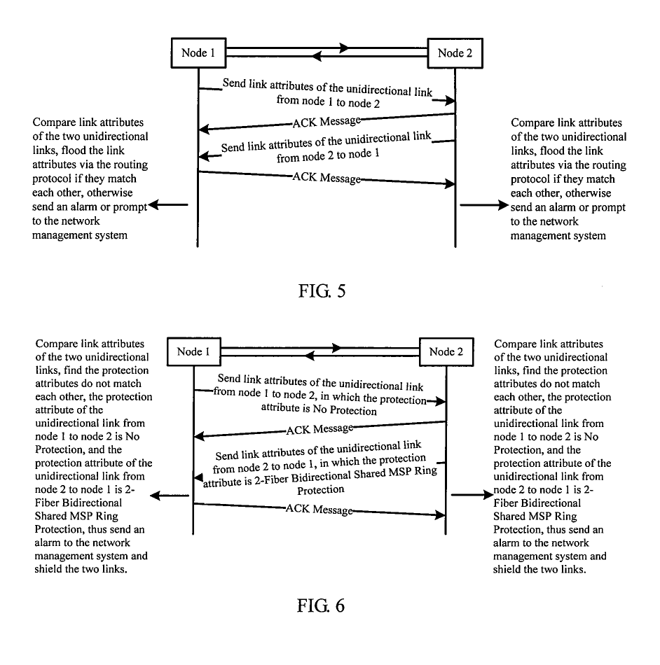

FIG. 5 shows a message flow of the method for verifying link attributes in a node of an ASON according to the first embodiment of the invention. As shown in FIG. 5, after completing the configuration of the link attributes, node 1 sends the link/link attribute message to the link management protocol module of node 2 by the link management protocol module of the control plane, and node 2 feeds back an ACK message to node 1 after receiving the link/link attribute message. Likewise, after completing the configuration of the link attributes, node 2 also sends the link/link attribute message to the link management protocol module of node 1 by the link management protocol module, and after receiving this message, the link management protocol module of node 1 feeds back an ACK messages to node 2. As described above, the link/link attribute messages sent by node 1 and node 2 respectively includes the link attributes of the unidirectional link from node 1 to node 2 and those of the unidirectional link from node 2 to node 1, such as the signal types, the local port identifiers, the remote port identifiers, the total bandwidths, the available bandwidths, the supportable maximum contiguous concatenation types, the protection attributes, and so on. After receiving the messages from the counterpart node, node 1 and node 2 verify the link attributes by using the method as described above respectively, according to the link attributes stored in the local databases and the link attributes contained in the messages.

FIG. 6 shows an example in which it is found that protection attributes of links do not match each other in a link verification process according to the first embodiment of the invention. After node 2 sends the link/link attribute messages to node 1 and node 1 feeds back the ACK message, node 1 finds that the protection attributes in two directions do not match each other by a comparison, in which the protection attribute of the unidirectional link from node 1 to node 2 is No Protection, whereas the link protection attribute of the unidirectional link from node 2 to node 1 is 2-Fiber Bidirectional Shared MSP Ring Protection. So, node 1 sends to the network management system an alarm indicating the mismatch of the protection attributes of the links, and shields the pair of unidirectional links at the same time. Correspondingly, node 2 also sends to the network management system an alarm indicating the mismatch of the protection attributes of the links, and shields the pair of unidirectional links at the same time.

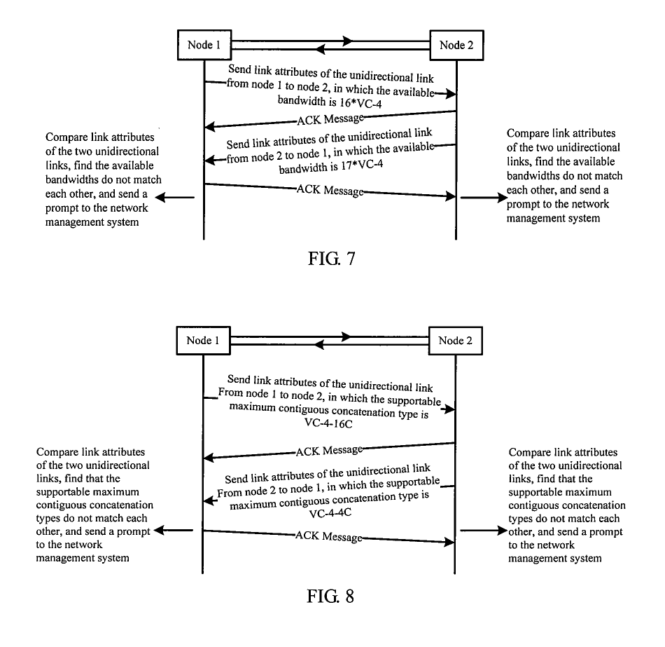

FIG. 7 shows an example in which it is found that available bandwidths do not match each other in a link verification process according to the first embodiment of the invention. Because the available bandwidth of the unidirectional link form node 1 to node 2 is 16*VC4, and the available bandwidth of the unidirectional link form node 2 to node 1 is 17*VC4, node 1 and node 2 both send prompts indicating the mismatch of the available bandwidths to the network management system, so as to prompt the maintenance personnel to take measures. At this time, the link attributes are still flooded to the entire network by using the routing protocol.

FIG. 8 shows an example in which it is found that supportable maximum contiguous concatenation types do not match each other in a link verification process according to the first embodiment of the invention. Because the supportable maximum contiguous concatenation type of the unidirectional link form node 1 to node 2 is VC-4-16C, and the supportable maximum contiguous concatenation type of the unidirectional link form node 2 to node 1 is VC-4-4C, node 1 and node 2 both send prompts indicating the mismatch of the supportable maximum contiguous concatenation types to the network management system, so as to prompt the maintenance personnel to take measures. At this time, the link attributes are still flooded to the entire network by using the routing protocol.

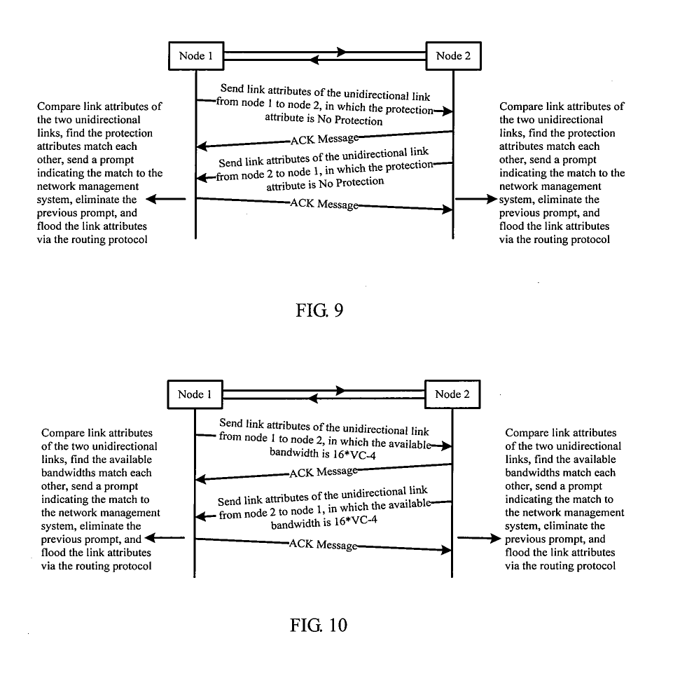

FIG. 9 shows an example of eliminating an alarm indicating a mismatch of protection attributes of links according to the first embodiment of the invention. When the mismatched protection attributes have been adjusted as described with reference to FIG. 3 and FIG. 4, the maintenance personnel triggers a link attribute verification process again. After node 2 sends the link/link attribute message to node 1 and node 1 feeds back the ACK message, node 1 finds that the protection attributes of the two unidirectional links become matching each other by a comparison. Node 2 also find the match of the protection attributes of the two unidirectional links. At this point, node 1 and node 2 both send prompts indicating the match of the link attributes to the network management system to eliminate the previous alarm, remove the shielding on the pair of unidirectional links, and flood the link attributes of the two unidirectional links to the entire network by using the routing protocol.

FIG. 10 shows an example of eliminating a prompt indicating a mismatch of available bandwidths of links according to the first embodiment of the invention. When the mismatched available bandwidths have been adjusted as described above, the maintenance personnel may trigger a link attribute verification process again. At this time, since the available bandwidth of the unidirectional link from node 1 to node 2 is 16*VC-4, and the available bandwidth of the unidirectional link from node 2 to node 1 has already been adjusted to 16*VC-4, node 1 and node 2 determine that the link attributes of the two unidirectional links match each other completely, and thus both send prompts indicating the match of the link attributes to the network management system to eliminate the previous prompt, and flood the adjusted link attributes which did not match each other previously to the entire network by using the routing protocol.

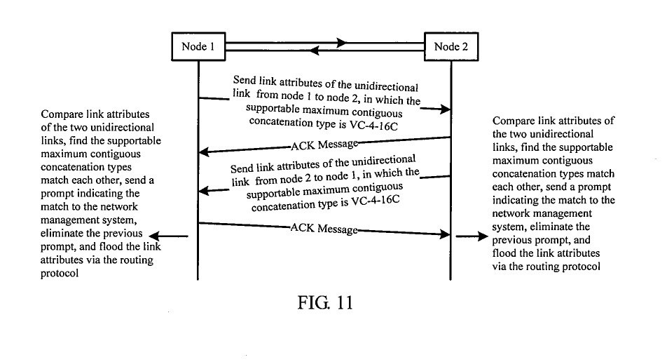

FIG. 11 shows an example of eliminating a prompt indicating a mismatch of supportable maximum contiguous concatenation types of links according to the first embodiment of the invention. When the mismatched supportable maximum contiguous concatenation types have been adjusted as described above, the maintenance personnel triggers a link attribute verification process again. Since the supportable maximum contiguous concatenation type of the unidirectional link from node 1 to node 2 is VC-4-16C, and the supportable maximum contiguous concatenation type of the unidirectional link from node 2 to node 1 has been adjusted to VC-4-16C, node 1 and node 2 determine that the link attributes of the two unidirectional links match each other completely, and thus both send prompts indicating the match of the link attributes to the network management system to eliminate the previous prompt, and flood the adjusted link attributes which did not match each other previously to the entire network by using the routing protocol.

In the first embodiment of the invention, when the link management protocol module 302 in node 1 finds that the link attributes of the unidirectional links between node 1 and node 2 do not match each other, it sends an alarm or a prompt based on the type of the mismatched link attributes; then the maintenance personnel judges, with respect to the prompt, whether the mismatch indicated by the prompt is normal. However, this increases the burden of the maintenance personnel unnecessarily because the prompt is also send for the normal mismatch. To solve this problem, the link attribute verification device and the link attribute verification method according to the first embodiment of the invention are improved.

A link attribute verification device according to a second embodiment of the invention has a structure substantially the same as that of the link attribute verification device according to the first embodiment of the invention, with the difference only in that the operations of the link management protocol modules are different. For simplicity, the structure and reference numerals shown in FIG. 3 are still used here, and only different parts are described.

In the second embodiment of the invention, when it is found that only the total bandwidths, the available bandwidths and the supportable maximum contiguous concatenation types of the two unidirectional links between node 1 and node 2 do not match each other, the link management protocol module 302 of node 1 judges whether the two unidirectional links carry unidirectional circuits, and whether the bandwidths and the contiguous concatenation types of the unidirectional circuits cause the mismatch of the corresponding link attributes, based on information on whether the two unidirectional links carry unidirectional circuits, and the bandwidths, the maximum contiguous concatenation types, and so on of the unidirectional circuits, which are stored in the local link databases of node 1 and/or node 2 when the links between node 1 and node 2 are established. If the two unidirectional links carry unidirectional circuits, and the bandwidths and the contiguous concatenation types of the unidirectional circuits cause the mismatch of the corresponding link attributes, this means the mismatch is normal, and at the time, the link management protocol module 302 sends the link attributes of the unidirectional link from node 1 to node 2 to the routing protocol module 304, then the routing protocol module 304 floods these link attribute to the entire network. Similarly, node 2 will also perform similar operations, and flood the link attributes of the unidirectional link from node 2 to node 1 to the entire network via the routing protocol module.

On the other hand, when determining that the two unidirectional links do not carry unidirectional circuits, or although the two unidirectional links carry unidirectional circuits, the bandwidths and the maximum contiguous concatenation types of these unidirectional circuits do not cause the mismatch of the total bandwidths, the available bandwidths, or the maximum contiguous concatenation types of the two unidirectional links, the link management protocol module 302 sends an alarm indicating the mismatch of the corresponding link attributes to the network management system 10, and then shields the two links between node 1 to node 2.

Next, the maintenance personnel adjusts, according to service attributes of the services carried by the two unidirectional links which are stored in the local link databases of node 1 and/or node 2, the mismatched link attributes to make them match each other, and triggers again verification processes performed by node 1 and node 2 on the link attributes of the two links. Since the previously mismatched link attributes have become matching each other, the link management protocol modules of node 1 and node 2 send prompts indicating the match to the network management system 10 respectively, so as to eliminate the previous alarms, and send the link attributes of the two links to the corresponding routing protocol modules respectively, so that the link attributes of the two links are flooded to the entire network by the routing protocol modules.

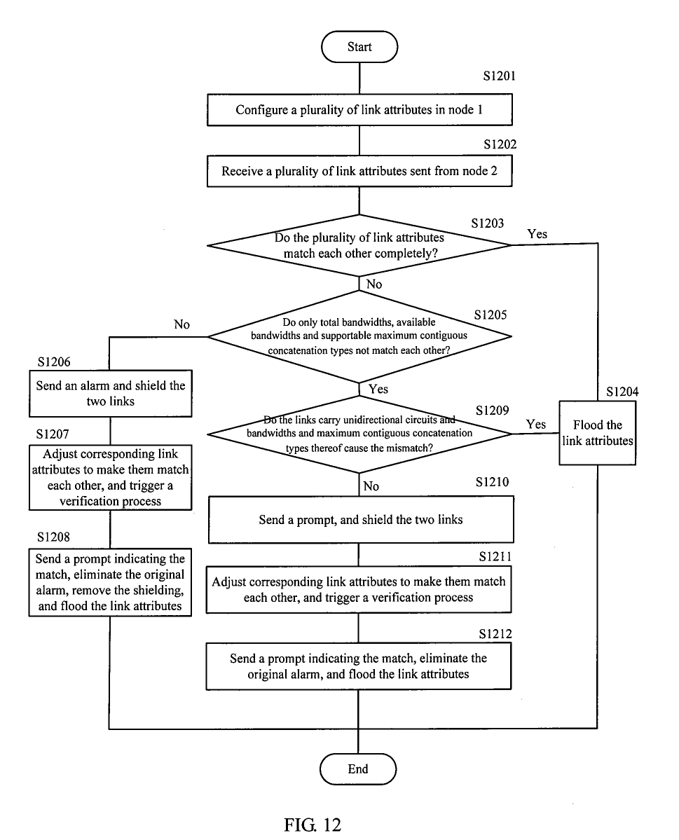

Hereinafter, a link attribute verification method according to the second embodiment of the invention will be described in conjunction with FIG. 12. FIG. 12 is a flow chart showing the method for verifying link attributes in a node of an ASON according to the second embodiment of the invention.

Steps S1201 to S1208 shown in FIG. 12 are the same as steps S401 to S408 in the method according to the first embodiment of the invention as shown in FIG. 4, respectively, and thus are not described here for simplicity.

When the link management protocol module 302 of node 1 finds in step S1205 that only one or more of the total bandwidths, the available bandwidths, and the supportable maximum contiguous concatenation types of the two unidirectional links do not match each other, the process proceeds to step S1209, in which the link management protocol module 302 judges whether the two unidirectional links between node 1 and node 2 carry unidirectional circuits, and whether the bandwidths or the contiguous concatenation types of the unidirectional circuits cause the mismatch of the corresponding link attributes, based on information on whether the two unidirectional links carry unidirectional circuits, and the bandwidths, the maximum contiguous concatenation types, and so on of the unidirectional circuits, which are stored in the local link databases of node 1 and/or node 2 when establishing the links between node 1 and node 2. If it is determined in step S1209 that the two unidirectional links carry unidirectional circuits, and the bandwidths or the maximum contiguous concatenation types of the unidirectional circuits cause the mismatch of the corresponding link attributes, this means the mismatch is normal, so the process proceeds to step S1204, in which the link management protocol module 302 sends the link attributes of the unidirectional link from node 1 to node 2 to the routing protocol module 304, then the routing protocol module 304 floods these link attributes to the entire network.

On the other hand, when it is determined in step S1209 that the two unidirectional links do not carry unidirectional circuits, or although the two unidirectional links carry unidirectional circuits, the bandwidths or the maximum contiguous concatenation types of these unidirectional circuits do not cause the mismatch of the total bandwidths, the available bandwidths, or the supportable maximum contiguous concatenation types of the two unidirectional links, the process proceeds to step S1210, in which the link management protocol module 302 sends an alarm indicating the mismatch of the corresponding link attributes to the network management system 10, and shields the two unidirectional links. Likewise, node 2 will also issue a similar alarm, and shields the two unidirectional links. Then, in step S1211, the maintenance personnel adjusts, according to the service attributes of the services carried by the two links which are stored in the local link databases of node 1 and/or node 2, the mismatched link attributes to make them match each other, and triggers again verification processes performed by node 1 and node 2 on the link attributes of the two links. Since the previously mismatched link attributes have been adjusted to match each other, the link management protocol modules of node 1 and node 2 find that the link attributes of the two links match each other completely, thus they send prompts indicating this match to the network management system 10 respectively so as to eliminate the previous alarms, and then send the link attributes of the two links to the routing protocol modules of the respective nodes, so that these link attributes are flooded to the entire network by the routing protocol modules. Then, the process ends.

Similarly, in the above triggered link attribute verification process, it is possible to verify all of the link attributes, or only those previously mismatched link attributes.

When the total bandwidths, the available bandwidths, and the supportable maximum contiguous concatenation types of the two unidirectional links between node 1 to node 2 do not match each other, the link attribute verification method and the link attribute verification device according to the second embodiment of the invention judge whether an alarm should be issued in advance according to related information stored in the local link databases, so that the number of alarms is decreased and the burden of the maintenance personnel is reduced.

It is to be appreciated that the modules for performing various functions as described hereinbefore not only can be constituted by various hardware, but also can be implemented by a combination of a common processor with computer software for performing the functions. In addition, although the link attribute verification device according to the embodiments of the invention are described as being constituted by several independent modules having different functions in the above, it is possible to re-combine these functions as required so that they are implemented by one or more modules.

Moreover, the method according to the embodiments of the invention may be embodied as computer-readable codes, instructions, or programs, and may be implemented in a general-purpose computer which executes the codes, the instructions, or the programs by using, for example, a computer-readable recording media. Examples of the computer-readable recording medium include magnetic storage media, such as ROM (read-only memory), floppy disk, hard disk, or the like, and optical recording media, such as CD-ROM (compact disc read-only memory) or DVD (Digital Versatile Disk). Furthermore, the method according to the embodiments of the invention may be embodied as a media containing computer-readable codes for executing the method.

Although the invention has been described with reference to particular embodiments thereof in the above, it is to be understood by those skilled in the art that various modifications in form and details may be made therein without departing from the scope and spirit of the present invention as defined by the following claims and equivalents thereof.

1-25. (canceled)

26. A method for verifying link attributes in a node of an Automatically Switched Optical Network, the node and another node being connected to a first port and a second port of one bidirectional link respectively, the bidirectional link being divided into a first unidirectional link from the first port to the second port and a second unidirectional link from the second port to the first port, the method comprising the steps of:
configuring a plurality of link attributes of the first unidirectional link in the node;
receiving in the node a plurality of link attributes of the second unidirectional link configured in the another node from the another node; and
comparing in the node the plurality of link attributes of the first unidirectional link with the received plurality of link attributes of the second unidirectional link respectively to check whether they match each other.

27. The method of claim 26 further comprising flooding the plurality of link attributes of the two unidirectional links to a entire network when it is determined in the comparing step that the plurality of link attributes of the first unidirectional link and the corresponding link attributes of the second unidirectional link match each other completely.

28. The method of claim 26, further comprising when it is determined in the comparing step that one or more of the plurality of links attributes of the first unidirectional link do not match corresponding link attributes of the second unidirectional link, issuing an alarm or prompt indicating the mismatch of the link attributes according to a type of the mismatched link attributes.

29. The method of claim 26, wherein the plurality of link attributes of the first unidirectional link or the second unidirectional link comprise one or more of a first port identifier, a second port identifier, a signal type, a total bandwidth, an available bandwidth, a supportable maximum contiguous concatenation type, and a protection attribute.

30. The method of claim 29, further comprising when it is determined in the comparing step that one or more of the plurality of links attributes of the first unidirectional link do not match corresponding link attributes of the second unidirectional link, issuing an alarm or prompt indicating the mismatch of the link attributes according to a type of the mismatched link attributes.

31. The method of claim 30, wherein when one or more of the first port identifier, the second port identifier, the signal type, and the protection attribute of the first unidirectional link do not match corresponding attributes of the second unidirectional link, an alarm indicating the mismatched link attributes is issued, and the two unidirectional links are shielded in the network.

32. The method of claim 31, further comprising the step of adjusting the mismatched link attributes by a user to make them match each other, and triggering a verification process on the mismatched link attributes.

33. The method of claim 32, further comprising when it is determined in the triggered verification process that the mismatched link attributes become matching each other, eliminating the alarm, removing the shielding on the two unidirectional links, and flooding the link attributes of the two unidirectional links to the entire network.

34. The method of claim 30, further comprising when it is determined in the comparing step that only one or more of the total bandwidth, the available bandwidth, and the supportable maximum contiguous concatenation type of the first unidirectional link do not match corresponding link attributes of the second unidirectional link, a prompt indicating the mismatch of the link attributes is issued, and the plurality of link attributes of the two unidirectional links are flooded to the entire network.

35. The method of claim 34, further comprising determining whether the first unidirectional link and the second unidirectional link carry unidirectional circuits, and whether available bandwidths and maximum contiguous concatenation types of the unidirectional circuits cause the mismatching;
removing the prompt when the two unidirectional links carry unidirectional circuits and the bandwidths and the maximum contiguous concatenation types thereof cause the mismatching; and
adjusting the mismatched attributes by a user to make them match each other and triggering a verification process on the link attributes, when the two unidirectional links do not carry unidirectional circuits, or although the two unidirectional links carry unidirectional circuits, the bandwidths and the maximum contiguous concatenation types of the unidirectional circuits do not cause the mismatch.

36. The method of claim 35, further comprising when it is determined in the triggered verification process that the mismatched link attributes become matching each other, eliminating the prompt, and flooding the adjusted link attributes which did not match each other previously to the entire network.

37. The method of claim 29, further comprising when it is determined in the comparing step that one or more of the total bandwidth, the available bandwidth, and the supportable maximum contiguous concatenation type of the first unidirectional link do not match corresponding link attributes of the second unidirectional link, determining whether the two unidirectional links carry unidirectional services, and whether bandwidths and maximum contiguous concatenation types of the circuits cause the mismatch;
flooding the plurality of attributes of the two unidirectional links to the entire network when it is determined that the two unidirectional links carry unidirectional services, and the bandwidths and the maximum contiguous concatenation types of the circuits cause the mismatch; and
issuing an alarm indicating the mismatched link attributes and shielding the two unidirectional links, when it is determined that the two unidirectional links do not carry unidirectional circuits, or although the two unidirectional links carry unidirectional circuits, the bandwidths and the maximum contiguous concatenation types of the circuits do not cause the mismatch.

38. The method of claim 37, wherein the step of determining whether the two unidirectional links carry unidirectional services, and whether the bandwidths and the maximum contiguous concatenation types of the circuits cause the mismatch is performed based on information on whether the two unidirectional links carry unidirectional circuits, and the bandwidths and the maximum contiguous concatenation types of the circuits, which are stored in the nodes.

39. The method of claim 37, further comprising adjusting by a user the mismatched link attributes to make them match each other and triggering a verification process on the plurality of link attributes, when receiving the alarm.

40. The method of claim 39, further comprising eliminating the alarm and flooding the plurality of link attributes of the two unidirectional links to the entire network, when it is determined in the triggered verification process that the mismatched link attributes become matching each other.

41. A device for verifying link attributes in a node of an Automatically Switched Optical Network, the node and another node being connected to a first port and a second port of one bidirectional link respectively, the bidirectional link being divided into a first unidirectional link from the first port to the second port and a second unidirectional link from the second port to the first port, the device comprising:
a local link database for storing a plurality of link attributes of the first unidirectional link configured in the node; and
a link management protocol module for receiving a plurality of link attributes of the second unidirectional link configured in the another node from the another node, and comparing the plurality of link attributes of the first unidirectional link stored in the local link database with the received plurality of link attributes of the second unidirectional link respectively to check whether they match each other.

42. The system of claim 41, further comprising a routing protocol module for flooding the plurality of link attributes of the two unidirectional links to the entire network when the link management protocol module determines that the plurality of link attributes of the first unidirectional link and the plurality of link attributes of the second unidirectional link match each other completely.

43. The system of claim 41, further comprising when determining that one or more of the links attributes of the first unidirectional link do not match corresponding link attributes of the second unidirectional link, the link management protocol module issues an alarm or prompt indicating the mismatch of the link attributes according to a type of the mismatched link attributes.

44. The system of claim 41, wherein the plurality of link attributes of the first unidirectional link or the second unidirectional link comprise one or more of a first port identifier, a second port identifier, a signal type, a total bandwidth, an available bandwidth, a supportable maximum contiguous concatenation type, and a protection attribute.

45. The system of claim 44, further comprising an auto-discovery module for configuring the first port identifier, the second port identifier, and the transmitted signal type of the first link by an automatic discovery, and wherein the plurality of link attributes in the local link database includes the link attributes configured by the auto-discovery module, link attributes configured by default, and link attributes configured by a network management system.

46. The system of claim 44, further comprising when determining that one or more of the links attributes of the first unidirectional link do not match corresponding link attributes of the second unidirectional link, the link management protocol module issues an alarm or prompt indicating the mismatch of the link attributes according to a type of the mismatched link attributes.

47. The system of claim 46, wherein when determining one or more of the first port identifier, the second port identifier, the signal type, and the protection attribute of the first unidirectional link do not match corresponding attributes of the second unidirectional link, the link management protocol module issues an alarm indicating the mismatched link attributes, and shields the two unidirectional links in the network.

48. The system of claim 46, wherein when determining that only one or more of the total bandwidth, the available bandwidth, and the supportable maximum contiguous concatenation type of the first unidirectional link do not match corresponding link attributes of the second unidirectional link, the link management protocol module issues a prompt indicating the mismatch of the link attributes, and routing protocol module floods the plurality of link attributes of the two unidirectional links to the entire network.

49. The system of claim 44, wherein when determining that one or more of the link total bandwidth, the link available bandwidth, and the link supportable maximum contiguous concatenation type of the first unidirectional link do not match corresponding link attributes of the second unidirectional link, the link management protocol module determines whether the two unidirectional links carry unidirectional circuits, and whether available bandwidths and maximum contiguous concatenation types of the circuits cause the mismatching; and
the link management protocol module floods the plurality of attributes of the two unidirectional links to the entire network when determining that the two unidirectional links carry unidirectional services, and the bandwidths and the maximum contiguous concatenation types of the circuits cause the mismatch, and
the link management protocol module issues an alarm indicating the mismatched link attributes and shields the two unidirectional links, when determining that the two unidirectional links do not carry unidirectional circuits, or although the two unidirectional links carry unidirectional circuits, the bandwidths and the maximum contiguous concatenation types of the circuits do not cause the mismatch.

50. The system of claim 49, wherein the link management protocol module determines whether the two unidirectional links carry unidirectional services, and whether the bandwidths and the maximum contiguous concatenation types of the circuits cause the mismatch, based on information on whether the two unidirectional links carry unidirectional circuits, and the bandwidths and the maximum contiguous concatenation types of the circuits, which are stored in the nodes.
